(19) United States
(12) Patent Application Publication
(10) Pub. No.: US 2017/0263384 A1
(43) Pub. Date: Sep. 14, 2017

(54) TUNGSTEN CAPACITOR ELEMENT AND METHOD FOR MANUFACTURING SAME

(71) Applicant: SHOWA DENKO K.K., Tokyo (JP)

(72) Inventors: Kazumi NAITO, Tokyo (JP); Shoji YABE, Tokyo (JP)

(73) Assignee: SHOWA DENKO K.K., Tokyo (JP)

(21) Appl. No.: 15/510,368

(22) PCT Filed: Jun. 12, 2015
(86) PCT No.: PCT/JP2015/066962

§ 371 Date: Mar. 10, 2017

(30) Foreign Application Priority Data
Sep. 11, 2014 (JP) 2014-184817

(51) Int. Cl. H01G 9/042; H01G 9/07; H01G 9/00; H01G 9/052

(52) U.S. Cl. CPC H01G 9/042; H01G 9/052; H01G 9/07; H01G 9/0032; H01G 9/0036

(57) ABSTRACT

A capacitor element sequentially including a dielectric layer containing an amorphous tungsten oxide, a layer coating a part or all of the dielectric layer and containing a crystalline tungsten oxide, a semiconductor layer and a conductor layer on a tungsten-containing anode body. The capacitor element is manufactured by a method including a sintering step of forming an anode body by sintering a formed body of a tungsten powder; a step of forming a dielectric layer by subjecting the anode body to a chemical conversion treatment; a step of forming a crystalline tungsten oxide layer on the dielectric layer; a step of forming a semiconductor layer for forming a semiconductor layer; and a step of forming a conductor layer for forming a conductor layer; in this order.

### TECHNICAL FIELD

The present invention relates to a tungsten capacitor element and a method for manufacturing the same. Specifically, the present invention relates to a capacitor element comprising an anode body containing tungsten, a dielectric layer, a semiconductor layer and a conductor layer; and a method for manufacturing the same.

### BACKGROUND ART

Patent Document 1 (WO 2013/186970) discloses a capacitor element comprising an anode body containing tungsten, a dielectric layer containing a tungsten oxide on the surface of the anode body, in which crystals are not substantially observed in the tungsten oxide of the dielectric layer by a scanning electron microscope.

### PRIOR ART

### Patent Documents

Patent Document 1: WO 2013/186970

### DISCLOSURE OF INVENTION

### Problem to be Solved by Invention

A capacitor element comprising a tungsten-containing anode body, a dielectric layer, a semiconductor layer and a conductor layer (hereinafter abbreviated as “a tungsten capacitor element”) is expected to be commercialized because the unit material cost of an anode body is low and the element has a large capacitance per volume.

However, there are issues to contend with, including increase in leakage current (LC) after subjecting the capacitor element to heat treatment at a high temperature, for example, in a sealing process and in the treatment in a reflow furnace.

Accordingly, an object of the present invention is to provide a high heat-resistance tungsten capacitor element, which is not susceptible to increase in LC after a high-temperature treatment; and a method for manufacturing the same.

### Means to Solve Problems

The present inventors have made study to determine the cause of increase in LC after the high-temperature heat treatment of a tungsten capacitor element.

As a result, they have found that a high heat-resistance tungsten capacitor element can be obtained by coating a part or all of the dielectric layer containing an amorphous tungsten oxide with a crystalline tungsten oxide. They have accomplished the present invention based on the finding.

That is, the present invention relates to the following [1] to [7].
[1] A capacitor element sequentially comprising a dielectric layer containing an amorphous tungsten oxide, a layer coating a part or all of the dielectric layer and containing a crystalline tungsten oxide, a semiconductor layer and a conductor layer on a tungsten-containing anode body.
[2] The capacitor element as described in [1] above, in which diffraction peaks derived from crystals are observed by X-ray diffraction in the crystalline tungsten oxide.
[3] The capacitor element as described in [1] above, in which a diffraction peak derived from crystals is not observed by X-ray diffraction in the amorphous tungsten oxide.
[4] The capacitor element as described in [2] or [3] above, in which the diffraction peaks derived from crystals include three peaks that appear at a diffraction angle 2θ=22° to 25°, a peak that appears at a diffraction angle 2θ=28° to 29°, a peak that appears at a diffraction angle 2θ=33° to 34°, and a peak that appears at a diffraction angle 2θ=36° to 37°.
[5] The capacitor element as described in any one of [1] to [3] above, in which the tungsten oxide is tungsten trioxide.
[6] A capacitor comprising the capacitor element described in any one of [1] to [5] above.
[7] A method for manufacturing the capacitor element described in any one of [1] to [5] above, comprising a sintering step of forming an anode body by sintering a tungsten powder or a formed body thereof; a step of forming a dielectric layer by conducting a chemical conversion treatment using a solution containing at least one member selected from a manganese(VII) compound, chromium (VI) compound, halogen acid compound, persulfuric acid compound and organic peroxide; a step of forming a crystalline tungsten oxide layer by impregnating the dielectric layer with a solution containing at least one member selected from tungstic acid, tungstate, a sol in which tungsten oxide particles are suspended, tungsten chelate, and a metal alkoxide containing tungsten and then conducting a heat treatment at 300° C. or higher; a step of forming a semiconductor layer for forming a semiconductor layer; and a step of forming a conductor layer for forming a conductor layer; in this order.

### BRIEF DESCRIPTION OF DRAWINGS

FIG. 1 is for showing the results of the X-ray diffraction analysis of the tungsten trioxide in Referential Example.

FIG. 2 is a scanning electron microscope image of the fracture surface of the anode body after the step of forming a crystalline tungsten oxide layer (magnification: 5×10⁴ times) in Example 1.

### MODE FOR CARRYING OUT INVENTION

With respect to a tungsten capacitor element, when the capacitor element is subjected to heat treatment at a high temperature, for example, in a sealing process and in the treatment in a reflow furnace, the degradation of the dielectric layer is caused in some cases due to the reduction action of the conductive polymer constituting the semiconductor layer. It is assumed that this results in increase in LC after the high-temperature heat treatment.

The present inventors considered that a crystalline tungsten oxide has a higher tolerance to the reduction action than an amorphous tungsten oxide and made studies. They have confirmed that the tolerance to the reduction action is improved by coating a part or all of the dielectric layer containing an amorphous tungsten oxide with a crystalline tungsten oxide, and have accomplished the present invention.

The capacitor element of the present invention sequentially comprises a dielectric layer containing an amorphous tungsten oxide, a layer coating a part or all of the dielectric layer and containing a crystalline tungsten oxide, a semiconductor layer and a conductor layer on a tungsten-containing anode body.

A crystalline tungsten oxide can be confirmed by a diffraction peak derived from crystals and observed by X-ray diffraction or by crystals observed by a scanning electron microscope.

The diffraction peaks derived from crystals observed by X-ray diffraction preferably include three peaks that appear at a diffraction angle 2θ=22° to 25°, a peak that appears at a diffraction angle 2θ=28° to 29°, a peak that appears at a diffraction angle 2θ=33° to 34°, and a peak that appears at a diffraction angle 2θ=36° to 37°.

A diffraction peak indicates a peak obtained at a peculiar diffraction angle and a diffraction intensity when a sample is irradiated with X-ray at various angles.

“A diffraction peak is observed” indicates a state in which the ratio (S/N) of a signal (S) to a noise (N) of a diffraction peak is 2 or more.

Diffraction peaks in X-ray diffraction can be measured by using, for example, an X-ray diffractometer X'pert PRO produced by PANalytical B.V. under the following conditions.
X-ray output (Cu—Kα): 45 kV, 40 mA
DS, SS: 0.5°, 0.5°
Goniometer radius: 240 mm

In the observation by a scanning electron microscope, the number of crystals observed in a field of view of 100 μm² under a scanning electron microscope is preferably 10 or more.

A layer containing a crystalline tungsten oxide is preferably a layer composed of a crystalline tungsten oxide. However, the layer may contain a small amount of impurities. For example, the layer may contain an amorphous tungsten oxide and other tungsten compounds in a small amount. The mass of the impurities is preferably 10 mass % or less, more preferably 5 mass % or less, still more preferably 3 mass % or less to the total mass of tungsten contained in a crystalline tungsten oxide.

Whether the tungsten oxide contained in a capacitor element is crystalline or not can be detected by subjecting a tungsten oxide produced by the same method to X-ray diffraction analysis or by observing it under a scanning electron microscope.

In the present invention, an amorphous tungsten oxide indicates the one in which no diffraction peak derived from crystals is observed in X-ray diffraction, or no substantial crystal is observed by a scanning electron microscope.

The diffraction peak derived from crystals and the conditions for measurement of the diffraction peak are as described above.

“No diffraction peak derived from crystals is observed in X-ray diffraction” indicates a state in which the ratio (S/N) of a signal (S) to a noise (N) of a diffraction peak is less than 2.

“No substantial crystal is observed by a scanning electron microscope” indicates a state in which the number of crystals observed in a field of view of 100 μm² under a scanning electron microscope is less than 10.

A dielectric layer containing an amorphous tungsten oxide is preferably a dielectric layer composed of an amorphous tungsten oxide. However, the layer may contain a small amount of impurities. For example, the layer may contain a crystalline tungsten oxide and other tungsten compounds in a small amount.

Whether the tungsten oxide contained in a capacitor element is amorphous or not can be detected by subjecting a tungsten oxide produced by the same method to X-ray diffraction analysis or by observing it under a scanning electron microscope.

In an amorphous tungsten oxide and a crystalline tungsten oxide, the tungsten oxide is preferably tungsten trioxide in either case.

In a capacitor element of the present invention, a layer containing a crystalline tungsten oxide covers a part or all of the dielectric layer containing an amorphous tungsten oxide.

The crystalline oxide covers preferably all of the layer comprising an amorphous tungsten oxide.

The thickness of the layer containing crystalline tungsten oxide is preferably 0.01 to 15 nm, more preferably 0.1 to 10 nm, still more preferably 1 to 10 nm. It should be noted that the thickness of the layer containing crystalline tungsten oxide can be measured by observation under a scanning electron microscope.

However, it is difficult to distinguish a dielectric layer containing amorphous tungsten oxide from a layer containing crystalline tungsten oxide by a scanning electron microscope. Therefore, the thickness of the dielectric layer containing amorphous tungsten oxide which was formed in advance is measured, and after forming a layer containing crystalline tungsten oxide, the increment in the layer thickness is calculated to be defined as the thickness of the layer containing crystalline tungsten oxide.

The capacitor element of the present invention can be manufactured by a method comprising a sintering step of forming an anode body by sintering a tungsten powder or a formed body thereof; a step of forming a dielectric layer by conducting a chemical conversion treatment using a solution containing at least one member selected from a manganese(VII) compound, chromium (VI) compound, halogen acid compound, persulfuric acid compound and organic peroxide; a step of forming a crystalline tungsten oxide layer by impregnating the dielectric layer with a solution containing at least one member selected from tungstic acid, tungstate, a sol in which tungsten oxide particles are suspended, tungsten chelate, and a metal alkoxide containing tungsten and then conducting a heat treatment at 300° C. or higher; a step of forming a semiconductor layer for forming a semiconductor layer; and a step of forming a conductor layer for forming a conductor layer; in this order.

Hereinafter the production method is to be described in details.

As a tungsten powder serving as a raw material of an anode body, either of a powder of a sole tungsten metal and a powder of a tungsten alloy can be used. Examples of the tungsten alloy include an alloy with a metal such as tantalum, niobium, aluminum, titanium, vanadium, zinc, molybdenum, hafnium, zirconium and bismuth. It should be noted that the tungsten element content in the anode body is preferably 50 mass % or more, more preferably 80 mass % or more, and still more preferably 90 mass % or more.

A commercially available product can be used as a tungsten powder.

A tungsten powder having a smaller particle diameter than a commercially available tungsten powder can be obtained, for example, by reducing tungsten trioxide powder under hydrogen atmosphere. The reduced tungsten powder may be pulverized using a pulverizing media.

The tungsten powder having a smaller particle diameter can also be obtained by a method of reducing tungstic acid or tungsten halide with a reducing agent such as hydrogen and sodium, and appropriately selecting the reducing conditions; or by a method of reducing the tungsten-containing mineral directly or through several steps and by selecting the reducing conditions.

The volume average particle diameter of the tungsten powder, D50 (a particle diameter when the accumulated volume % corresponds to 50 volume % in the volume basis particle diameter cumulative distribution), is preferably 0.1 to 0.6 μm, more preferably 0.1 to 0.5 μm, and still more preferably 0.1 to 0.4 μm. The volume average particle diameter D50 can be determined by measuring the volume basis particle diameter distribution using a commercially available device (for example, HRA9320-X100 (laser diffraction/scattering method particle size analyzer) manufactured by Microtrac Inc.).

As a tungsten powder, either of ungranulated tungsten powder (hereinafter may be referred to as “primary powder”) or granulated tungsten powder (hereinafter may be referred to as “granulated powder”) may be used. The granulated powder is preferable from the viewpoint of ease in forming fine pores in the anode body.

A tungsten powder containing at least one member selected from tungsten silicide, tungsten containing nitrogen solid solution, tungsten carbide and tungsten boride can be used as a tungsten powder.

In “tungsten silicide” of the present invention, all of the tungsten is not necessarily silicified. For example, tungsten silicide may exist only in the surface region of the particles.

Also, a tungsten powder may contain phosphorus and oxygen elements.

A silicified tungsten powder can be obtained by, for example, mixing a silicon powder into a tungsten powder and heating the mixture under reduced pressure.

The low-pressure condition at the time of silicifying the tungsten powder is preferably 100 Pa or lower, more preferably 10 Pa or lower. The reaction temperature is preferably 1,100° C. to 2,600° C.

As an example of the method for incorporating nitrogen solid solution in the tungsten powder, there is a method of placing the tungsten powder at 350 to 1,500° C. under reduced pressure of a nitrogen gas atmosphere for from several minutes to several hours.

As an example of the method for carbonizing a tungsten powder, there is a method of placing the tungsten powder at 300 to 1,500° C. under reduced pressure in a high temperature vacuum furnace using carbon electrodes for from several minutes to several hours.

As an example of the method for boronizing a tungsten powder, there is a method of mixing boron or a boron-containing compound as a boron source with the tungsten powder in advance and granulating the mixture.

To attain better LC characteristics, the tungsten powder in which the surface region of particles is silicified is preferable to keep the total content of impurity elements other than each element of silicon, nitrogen, carbon, boron, oxygen and phosphorus in the powder to 0.1 mass % or less. In order to keep the content of these elements to the above-mentioned value or lower, the amount of the impurity elements contained in the raw materials, a pulverizing member to be used, containers and the like should be kept low.

It is preferable to subject the above-mentioned tungsten powder to molding treatment before sintering the powder to be made into a formed body. For example, a formed body may be produced by mixing resin for molding (such as acrylic resin) with the tungsten powder and using a molding machine. The tungsten powder to be molded may be either of a primary powder, a granulated powder, and a mixed powder of a primary powder and a granulated powder (a partially granulated powder).

In the formation of the tungsten powder, an anode lead wire serving as a terminal of the anode body may be embedded and implanted in the formed body. As an anode lead wire, a valve-acting metal wire can be used, and also a metal plate or a metal foil may be implanted in or connected to the anode body.

[Sintering Step]

In the sintering step, an anode body is formed by sintering a tungsten powder or a formed body thereof. By sintering, a porous body having fine pores between particles is formed, in which a specific surface area increases. In addition, treatment for silicifying, boronizing, carbonizing, and incorporating nitrogen, phosphorus and the like can be conducted at the time of sintering.

The sintering temperature is preferably 1,000 to 2,000° C., more preferably 1,100 to 1,700° C., and still more preferably 1,200 to 1,600° C. The sintering time is preferably 10 to 50 minutes, more preferably 15 to 30 minutes. The sintering is conducted preferably under reduced pressure, more preferably in vacuum.

[Step of Forming a Dielectric Layer]

In the step of forming a dielectric layer, chemical conversion treatment is conducted using a solution containing at least one member selected from a group consisting of a manganese(VII) compound, chromium (VI) compound, halogen acid compound, persulfuric acid compound and organic peroxide, to thereby form a dielectric layer containing amorphous tungsten oxide.

Examples of a manganese(VII) compound include permanganate.

Examples of a chromium(VI) compound include chromium trioxide, chromate and dichromate.

Examples of a halogen acid compound include perchloric acid, chlorous acid, hypochlorous acid and salts thereof.

Examples of a persulfric acid compound include persulfuric acid and salts thereof.

Examples of an organic peroxide include peracetic acid, perbenzoic acid, and salts and derivatives thereof.

These oxidizing agents may be used singly or in combination of two or more thereof.

Among these, a persulfric acid compound such as ammonium persulfate, potassium persulfate, potassium hydrogen persulfate and sodium persulfate is preferable from the viewpoint of ease in handling, stability as an oxidizing agent, solubility in water, and capability of increasing a capacitance.

As a solvent of the solution for conducting chemical conversion treatment, water, methanol, ethanol, propanol and ethylene glycol can be used. Among these, it is desirable to use water, or a mixed solution of water and the above-mentioned solvent.

The content of the oxidizing agent is preferably 0.05 to 12 mass %, more preferably 0.05 to 7 mass %, still more preferably 1 to 5 mass %, in the solution in use for chemical conversion.

The chemical conversion solution may comprise a known electrolyte within a scope which does not affect the performance of the capacitor element. Examples of the electrolyte include acid such as nitric acid, sulfuric acid, boric acid, oxalic acid, adipic acid and phosphoric acid; and alkali metal salts and ammonium salts thereof.

The chemical conversion process may be repeated several times.

After conducting the chemical conversion treatment using a solution containing an oxidizing agent, chemical conversion using a solution containing an electrolyte may be conducted as needed.

In the chemical conversion process, the anode body is immersed in the above-mentioned solution and voltage is applied thereto. Voltage is applied between the anode body (anode) and a counter electrode (cathode). An electric current can be passed to the anode body through an anode lead wire.

Applying voltage starts at a predetermined initial current density. The current density is maintained and after the voltage reaches a predetermined value (formation voltage), it is preferable to maintain the voltage value. The formation voltage can be appropriately configured depending on a desired withstand voltage.

The temperature of the chemical conversion treatment is preferably 62° C. or lower, more preferably 0 to 60° C., and still more preferably 5 to 50° C.

The chemical conversion treatment time is preferably from 1 to 10 hours, more preferably from 3 to 10 hours, and still more preferably from 3 to 7 hours.

In the chemical conversion, a known jig may be used. Examples of the jig include the one disclosed by Japanese Patent No. 4620184 (U.S. Pat. No. 8,847,437).

After the chemical conversion treatment, the anode body may be washed with water to remove a solution attached to the anode body.

After washing with water, it is desirable to conduct water removal treatment by heating the anode body. Water removal treatment may be conducted by bringing the anode body into contact with a water-miscible solvent (propanol, ethanol, methanol and the like), followed by heating.

Whether the layer obtained in this step is a dielectric layer containing amorphous tungsten oxide or not can be detected by subjecting the tungsten oxide produced by the same method to X-ray diffraction analysis or by observing it under a scanning electron microscope.

[Step of Forming Layer of Crystalline Tungsten Oxide]

In the step of forming a layer of crystalline tungsten oxide, a layer comprising crystalline tungsten oxide is formed by impregnating the dielectric layer with a solution containing at least one member selected from tungstic acid, tungstate, a sol in which tungsten oxide particles are suspended, tungsten chelate, and a metal alkoxide containing tungsten and then conducting a heat treatment at 300° C. or higher.

The solution that penetrates into the dielectric layer may contain acetic acid tungsten, tungsten acetate and the like other than the above-described compounds.

Examples of tungstate include a tungsten-containing metal salt, a tungsten-containing ammonium salt, tungsten sulfate, and tungsten hydroxide.

Examples of a tungsten-containing metal salt include sodium tungstate and potassium tungstate.

Examples of a tungsten-containing ammonium salt include ammonium tungstate and tetramethylammonium tungstate.

In a sol in which tungsten oxide particles are suspended, there is no particular limit on the suspending method.

As a tungsten chelate, for example, the one that comprises a tungsten atom as a core metal and forms a 4-membered ring can be used. Specific examples thereof include the one in which 2-mercaptopyrimidine coordinates with tungsten to form a four-coordinate ligand.

Examples of a metal alkoxide containing tungsten include pentaethoxy tungsten, pentamethoxy tungsten, pentapropoxy tungsten and pentabutoxy tungsten.

A solution that penetrates into the dielectric layer is preferably a tungstate-containing solution and more preferably, a solution containing a tungsten-containing ammonium salt. A solution containing ammonium tungstate has a low probability of causing degradation of a dielectric layer and is more preferable.

As a solvent of the solution that penetrates into the dielectric layer, water, or a mixed solvent of water and a hydroxyl group-containing liquid such as alcohol, can be used.

The concentration of tungstate in a tungstate solution can be determined by evaluating a concentration at which the solution can readily penetrate into the dielectric layer by a preliminary experiment, and is generally 0.01 mass % or more and a saturated solubility or less. The concentration is preferably 0.01 to 10 mass %, more preferably 0.1 to 5 mass % and still more preferably 0.1 to 1 mass %.

After impregnating the dielectric layer with a solution, it is desirable to conduct drying treatment to remove the solvent prior to conducting heat treatment at 300° C. or higher. By this, bumping can be prevented.

The drying treatment temperature is preferably 80° C. or higher, more preferably 80 to 105° C., and still more preferably 90 to 105° C.

The drying treatment time is preferably 30 to 120 minutes, more preferably 30 to 100 minutes, and still more preferably 30 to 80 minutes.

After impregnating the dielectric layer with a solution, heat treatment is conducted at 300° C. or higher. By this, compounds contained in the solution that penetrated into the dielectric layer are thermally decomposed to be made into crystalline tungsten oxide.

With respect to the atmosphere, the heat treatment is conducted preferably under reduced pressure or an inert gas atmosphere, due to low probability of causing air oxidation of the anode body.

Examples of an inert gas include a nitrogen gas and an argon gas.

It is not necessary to thermally decompose all of the solution that penetrated into the dielectric layer and an unreacted portion may remain. For example, when a tungsten-containing ammonium salt is used in a solution that penetrates into a dielectric layer, the residual content of the tungsten-containing ammonium salt can be confirmed by measuring the nitrogen content. At this time, the residual nitrogen content is preferably 10 mass % or less, more preferably 5 mass % or less, and still more preferably 3 mass % or less to the tungsten contained in the dielectric layer.

The heat treatment temperature is preferably 300 to 800° C., more preferably 300 to 600° C., and still more preferably 300 to 500° C.

The heat treatment time is preferably 30 to 120 minutes, more preferably 30 to 100 minutes, and still more preferably 30 to 80 minutes.

The operation from the penetration of the tungstate solution to the heat treatment may be conducted multiple times.

It is desirable to conduct post-chemical conversion treatment to repair the dielectric layer and a layer containing crystalline tungsten oxide after forming a crystalline tungsten oxide layer and before forming a semiconductor layer.

The post-chemical conversion can be conducted in the same way as in the chemical conversion treatment. That is, the process can be conducted by immersing an anode body having a semiconductor layer formed thereon in a solution similar to the one used in the chemical conversion treatment and by applying a predetermined voltage between the anode body (anode) and a counter electrode (cathode) for a predetermined time.

At this time, using ammonium persulfate as an electrolyte facilitates the repair of the dielectric layer and is desirable.

After the post-chemical conversion, washing with water and water removal treatment may be conducted in the same way as after forming a dielectric layer.

Whether the layer obtained by this step is a dielectric layer containing crystalline tungsten oxide or not can be detected by subjecting a tungsten oxide produced by the same method to X-ray diffraction analysis or by observing it under a scanning electron microscope.

[Step of Forming a Semiconductor Layer]

The step of forming a semiconductor layer can be conducted by a conventional method.

As a conductive polymer constituting the semiconductor layer, a generally-used one such as polyethylenedioxythiophene, polypyrrole, or a derivative and a mixture thereof can be used. Before, after or during the formation of a semiconductor layer, a layer comprising manganese dioxide or a layer dotted with manganese dioxide may be formed.

The liquid used for polymerization of the conductive polymer may contain dopants. Examples of the dopants include toluenesulfonic acid, anthraquinonesulfonic acid, benzoquinonesulfonic acid, naphthalenesulfonic acid, polystyrenesulfonic acid and a salt thereof.

Either of chemical polymerization and electrolytic polymerization may be used for the polymerization of a conductive polymer, and both may be conducted repeatedly.

Chemical polymerization can be conducted by immersing the anode body in a polymerization liquid.

Electrolytic polymerization can be conducted by immersing the anode body in a polymerization liquid and applying a voltage thereto. A voltage can be applied in the same way as in the electrolytic oxidation in the chemical conversion treatment, and it is desirable to pass current under constant current conditions.

The concentrations of the conductive polymer and the dopant, the polymerization temperature, and the polymerization time can be determined according to a usual method.

After the formation of a semiconductor layer, washing with water and water removal treatment may be conducted in the same way as after forming a dielectric layer.

After forming a semiconductor layer, the above-described post-chemical conversion treatment may be conducted.

The operations from the electrolytic polymerization to the post-chemical conversion treatment may be conducted repeatedly.

<Step of Forming a Conductor Layer>

In the step of forming a semiconductor layer, a conductor layer is formed on the anode body having a semiconductor layer formed thereon by the above-described method. The conductor layer can be formed by a usual method, and examples thereof include a method of sequentially laminating a silver layer on a carbon layer.

The capacitor element as discussed above can be made into solid electrolytic capacitor products for various uses with an outer jacket formed by resin molding and the like.

A cathode lead is electrically connected to the conductor layer, and a part of the cathode lead is exposed outside the outer jacket of the capacitor to serve as a cathode external terminal. On the other hand, an anode lead is electrically connected to the anode body through an anode lead wire, and a part of the anode lead is exposed outside the outer jacket of the capacitor to serve as an anode external terminal.

According to the method of the present invention, a capacitor can be mounted on various electric circuits or electronic circuits to be used.

### EXAMPLES

The present invention is described below by referring to Examples and Comparative Examples, but the present invention is not limited thereto.

With respect to the particle diameter (volume-average particle diameter) of a powder, a volume-based particle size distribution was measured by using HRA9320-X100 (laser diffraction/scattering method particle size analyzer) manufactured by Microtrac Inc. A particle size value when the accumulated volume % corresponded to 50%, 10% and 90% in the particle size distribution were designated as the volume-average particle size D50 (μm), D10 (μm) and D90 (μm), respectively.

X-ray diffraction analysis was conducted by using an X-ray diffractometer X'pert PRO MPD produced by PANalytical B.V. under the following conditions.
X-ray output (Cu—Kα): 45 kV, 40 mA
DS, SS: 0.5°, 0.5°
Goniometer radius: 240 mm

It was judged as being a diffraction peak when the ratio (S/N) of a signal (S) to a noise (N) of a diffraction peak is 2 or more, while it was judged as not being a diffraction peak when the ratio is less than 2. It is to be noted that the noise (N) represents the noise amplitude measured using the baseline.

### Referential Example

Ammonium tungstate was heated in vacuum at 300° C. to obtain tungsten trioxide.

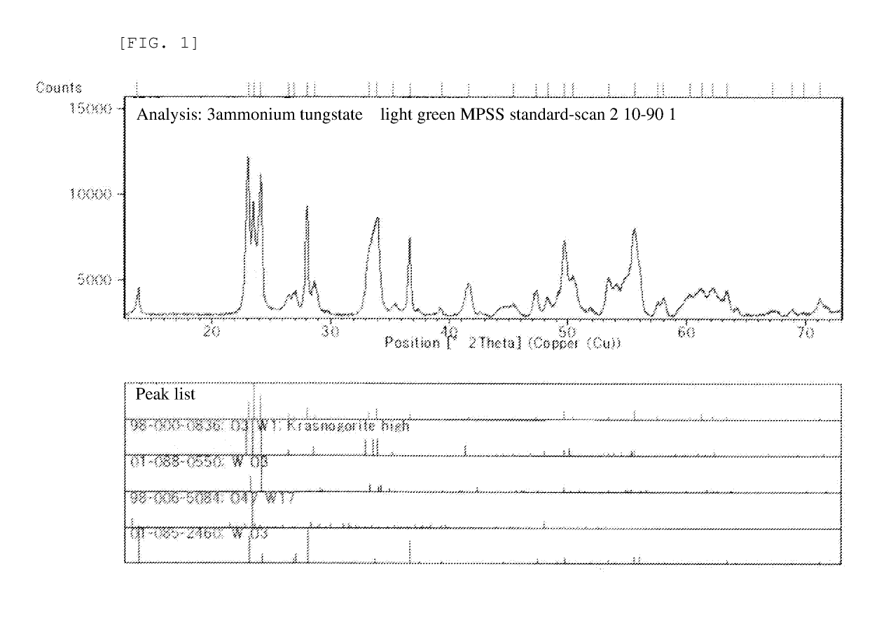

The results of the X-ray diffraction analysis are shown in FIG. 1. Since three peaks that appear at a diffraction angle 2θ=22° to 25°, a peak that appears at a diffraction angle 2θ=28° to 29°, a peak that appears at a diffraction angle 2θ=33° to 34°, and a peak that appears at a diffraction angle 2θ=36° to 37° were observed in FIG. 1, the obtained tungsten trioxide was considered to be crystalline.

The mass decrease rate was 23 to 25 mass %.

### Example 1

### (1) Sintering Step

A tungsten powder (volume-average particle diameter D50: 0.2 μm, volume-average particle diameter D10: 0.03 μm, volume-average particle diameter D90: 7 μm) was mixed with a commercially-available silicon powder (average particle diameter: 0.7 μm), and heated in vacuum at 1,100° C. for 30 minutes. After the heating, the powder was cooled to room temperature and then taken out to air, followed by pulverizing. After forming the obtained tungsten granulated powder (sieve classification: 180 μm or less, bulk density: 2.75 g/cm³) with a tantalum wire having a diameter of 0.24 mm, the formed bodies were sintered in vacuum at 1,260° C. for 30 minutes to produce 1,000 pieces of anode body having a size of 1.0×2.3×1.7 mm. A tantalum wire as an anode lead wire was implanted in the center of the 1.0×2.3 mm surface.

(2) Step of Forming a Dielectric Layer

The tantalum wire of the anode body was plugged into a joint socket of the same jig as that used in Example 1 of Japanese Patent No. 4620184 to array 64 pieces of the anode bodies. Using the jig, the anode body and the predetermined part of the tantalum wire were immersed in an aqueous solution of 3 mass % ammonium persulfate and chemical conversion treatment was conducted at 10° C., 10 V and an initial current density of 2 mA/anode body for 5 hours.

Subsequently, after washing the anode body with water, the anode body was immersed in ethanol and taken out, heated at 100° C. for 15 minutes, and further heated at 190° C. for 15 minutes to conduct water removal treatment.

It is to be noted that the chemical conversion treatment in this step is conducted by a method according to known technology and it is known that the tungsten oxide obtained by the method is amorphous. Accordingly, the dielectric layer formed in this step was considered to be a layer comprising amorphous tungsten oxide.

It was confirmed that the thickness of the dielectric layer was 25 nm by the observation under a scanning electron microscope.

(3) Step of Forming a Crystalline Tungsten Oxide Layer

After immersing the anode body having a dielectric layer formed thereon in an aqueous solution of 0.8 mass % ammonium tungstate for 5 minutes, the anode body was placed in a vacuum dryer to conduct drying treatment at 90° C. for 50 minutes. Then, the anode body was pulled out from the jig, plugged into a ceramic socket, and heated in a vacuum furnace at 300° C. for 45 minutes to make ammonium tungstate into tungsten trioxide.

It is to be noted that in this step, tungsten trioxide was produced by the same method as in Referential Example. Since the tungsten trioxide obtained in Referential Example was crystalline, the tungsten trioxide obtained in this step was considered to be crystalline.

It was confirmed by X-ray photoelectron spectroscopic analysis that nitrogen exists in the anode body and that about 3 mass % of ammonium tungstate among the ammonium tungstate impregnated as a raw material remained without being thermally decomposed.

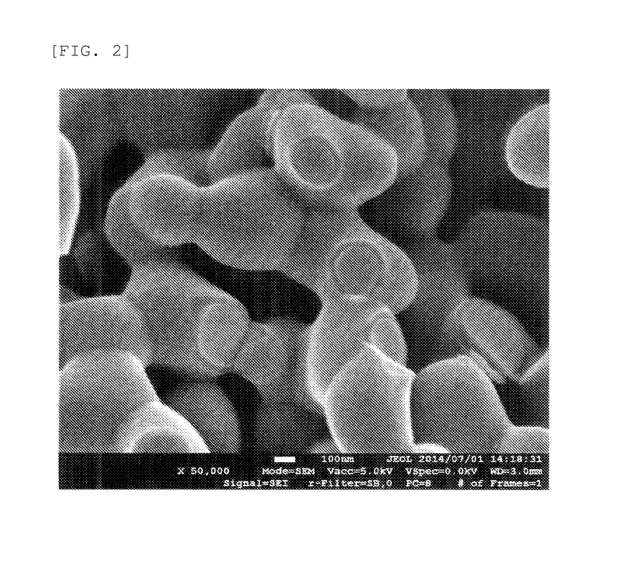

By the observation under a scanning electron microscope, it was confirmed that crystalline tungsten trioxide covered the dielectric layer and formed an 8 nm-thick layer (see FIG. 2).

Next, the anode body was pulled out from the socket and plugged into the above-mentioned jig to conduct post-chemical conversion treatment. As a solution used in the post-chemical conversion treatment, the same solution as that used in the above-mentioned chemical conversion treatment was used and the post-chemical conversion treatment was conducted at 25° C., 8V and a current density of 0.5 mA/anode body for 15 minutes.

(4) Step of Forming a Semiconductor Layer

After immersing the anode body in an ethanol solution of 10 mass % ethylenedioxythiophene, chemical polymerization was conducted using a separately prepared aqueous solution of 10 mass % iron toluenesulfonate at 60° C. The series of the operations from the immersion to chemical polymerization was repeated three times.

Subsequently, after immersing the anode body in an ethanol solution of 10 mass % ethylenedioxythiophene, a solution containing 3 mass % of anthraquinone sulfonic acid and ethylenedioxythiophene ethanol in a saturated amount or more, in which the mass ratio of water to ethylene glycol was 7:3, was prepared as a monomer solution for electrolytic polymerization. The solution was put in a stainless-steel container, and the anode body was immersed in the solution to conduct electrolytic polymerization. In the electrolytic polymerization, the tantalum wire and the stainless-steel container were connected to the positive electrode and the negative electrode of the power source, respectively, and the polymerization was conducted under the constant current condition of 60 μA/anode body at 25° C. for one hour.

Subsequently, after washing the anode body with water, the anode body was immersed in alcohol and taken out, and heated at 80° C.

Next, post-chemical conversion treatment was conducted at 8 V for 15 minutes by using the same solution as that used in the above-described chemical conversion treatment.

The series of the above-described operations from the electrolytic polymerization to post-chemical conversion was repeated five times. The current value of the electrolytic polymerization was set to 70 μA/anode body in the second and third rounds, and 75 μA/anode body in the fourth to fifth rounds.

(5) Step of Forming a Conductor Layer

Subsequently, a carbon layer and a silver layer were sequentially formed on the surface of the semiconductor layer except for the surface in which a tantalum wire was implanted, and 64 pieces of tantalum solid electrolytic capacitor elements were produced.

### Comparative Example 1

### (1) Sintering Step

The step was conducted in the same way as in Example 1.

### (2) Step of Forming a Dielectric Layer

The step was conducted in the same way as in Example 1 except that the voltage of chemical conversion treatment and the voltage of post-chemical conversion were set to 15 V and 12 V, respectively.

It was confirmed that the thickness of the dielectric layer was 33 nm by observation under a scanning electron microscope.

### (3) Step of Forming a Crystalline Tungsten Oxide Layer

The step was not conducted.

### (4) Step of Forming a Semiconductor Layer

The step was conducted in the same way as in Example 1 except that the voltage of post-chemical conversion treatment were set to 12V.

### (5) Step of Forming a Conductor Layer

The step was conducted in the same way as in Example 1.

The average values of the initial LC value and the LC value after the high-temperature heat treatment of the capacitor elements obtained in Example 1 and Comparative Example 1 are shown in Table 1.

It is to be noted that in the high-temperature heat treatment, capacitor elements were heated in air at 200° C. for 15 minutes. The values shown as “after high-temperature heat treatment” in Table 1 are the value measured after cooling the capacitor elements to room temperature after the high-temperature heat treatment.

The LC value is the value measured 30 seconds after applying a voltage of 2.5 V at 25° C.

TABLE 1

| | Initial LC | LC value after high- |
|---|---|---|
| | value | temperature heat treatment |
| Example 1 | 64 μA | 89 μA |
| Comparative | 70 μA | 842 μA |
| Example 1 | | |

It was confirmed from Table 1 that the capacitor element of Example 1 in which a dielectric layer was covered by crystalline tungsten oxide had a lower LC value after the high-temperature heat treatment than the capacitor element of Comparative Example 1 in which crystalline tungsten oxide was not formed.

1. A capacitor element sequentially comprising a dielectric layer containing an amorphous tungsten oxide, a layer coating a part or all of the dielectric layer and containing a crystalline tungsten oxide, a semiconductor layer and a conductor layer on a tungsten-containing anode body.

2. The capacitor element as claimed in claim 1, in which diffraction peaks derived from crystals are observed by X-ray diffraction in the crystalline tungsten oxide.

3. The capacitor element as claimed in claim 1, in which a diffraction peak derived from crystals is not observed by X-ray diffraction in the amorphous tungsten oxide.

4. The capacitor element as claimed in claim 2, in which the diffraction peaks derived from crystals include three peaks that appear at a diffraction angle 2θ=22° to 25°, a peak that appears at a diffraction angle 2θ=28° to 29°, a peak that appears at a diffraction angle 2θ=33° to 34°, and a peak that appears at a diffraction angle 2θ=36° to 37°.

5. The capacitor element as claimed in claim 1, in which the tungsten oxide is tungsten trioxide.

6. A capacitor comprising the capacitor element claimed in claim 1.

7. A method for manufacturing the capacitor element claimed in claim 1, comprising a sintering step of forming an anode body by tungsten powder or a formed body thereof; a step of forming a dielectric layer by conducting a chemical conversion treatment using a solution containing at least one member selected from a manganese(VII) compound, chromium (VI) compound, halogen acid compound, persulfuric acid compound and organic peroxide; a step of forming a crystalline tungsten oxide layer by impregnating the dielectric layer with a solution containing at least one member selected from tungstic acid, tungstate, a sol in which tungsten oxide particles are suspended, tungsten chelate, and a metal alkoxide containing tungsten and then conducting a heat treatment at 300° C. or higher; a step of forming a semiconductor layer for forming a semiconductor layer; and a step of forming a conductor layer for forming a conductor layer; in this order.
